(19) United States
(12) Patent Application Publication
(10) Pub. No.: US 2012/0075869 A1
(43) Pub. Date: Mar. 29, 2012

(54) LED ILLUMINATING DEVICE WITH PRISM SHEET

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/046,782

(22) Filed: Mar. 14, 2011

(30) Foreign Application Priority Data
Sep. 24, 2010 (CN) 201010289393.4

(51) Int. Cl. F21V 5/02

(52) U.S. Cl. 362/311.02

(57) ABSTRACT

An LED illuminating device contains a housing with a base plate, a prism sheet and a circuit board. The prism sheet is mounted in the housing and includes a number of V-shaped micro-grooves along at least two directions intersecting with each other. The circuit board arranged multiple of LED illuminating arrays is fixed on the base plate. Each LED illuminating array is made of two LED units spaced apart a third preset distance. At least four virtual light sources are formed by the reflection of prism sheet to the circuit board after the light emitted by a particular LED unit on the circuit board. The rows and the columns of the matrix are respectively spaced apart a first preset distance and a second preset distance.

### BACKGROUND

1. Technical Field

The present disclosure relates to light emitting diode (LED) illuminating devices, especially to an LED illuminating device with prism sheet.

2. Description of Related Art

In comparison to other kinds of illuminating devices, LED illuminating devices have advantages such as high luminous efficiency, low power consumption, and long service life. Despite its many advantages, the luminous intensity of an LED is limited. This disadvantage requires quite a number of LEDs for a large lighting system to reach a desired luminance.

Therefore, what is needed is an LED illuminating device that can reduce the number of LEDs used, yet still achieve a desirable level of the luminance.

### BRIEF DESCRIPTION OF THE DRAWINGS

Many aspects of the embodiments can be better understood with reference to the following drawings. The components in the drawings are not necessarily drawn to scale. The emphasis is instead being placed upon clearly illustrating the principles of the present disclosure. Moreover, in the drawings, like reference numerals designate corresponding parts throughout the several views.

FIG. 1 is a cross-sectional view of an LED illuminating device according to an embodiment.

FIG. 2 is an isometric view of a prism sheet of the LED illuminating device of FIG. 1.

FIG. 3 is a schematic side view showing the LED illuminating device that forms a number of virtual light sources.

FIG. 4 is a schematic planar view showing the arrangement of partial virtual light sources formed by the LED illuminating device FIG. 3.

FIG. 5 is a schematic planar view showing an LED array.

FIG. 6 is a schematic view of the virtual light sources formed by the LED array of FIG. 5.

### DETAILED DESCRIPTION

Embodiments of the present disclosure are now described in detail, with reference to the accompanying drawings.

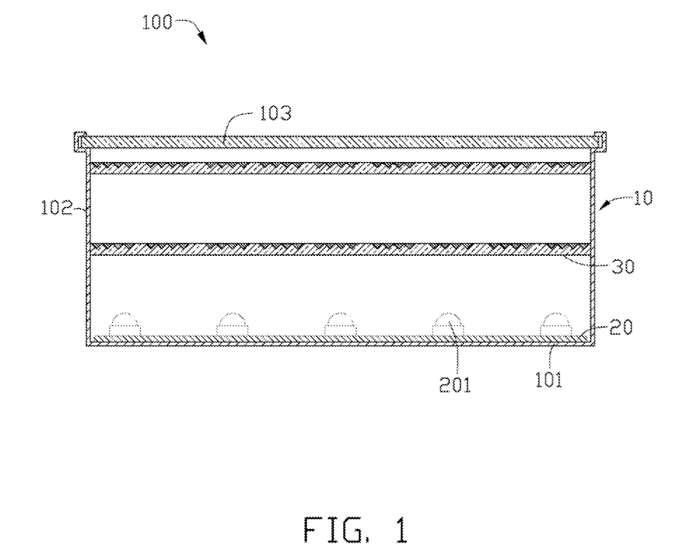

Referring to FIG. 1, an LED illuminating device 100 according to an embodiment is disclosed. The LED illuminating device 100 includes a housing 10, a circuit board 20, and a prism sheet 30. At least one LED unit 201 is arranged on the circuit board 20 and the color emitted by each LED unit 201 is the same as the other LED unit 201. The housing 10 includes a base plate 101, a sidewall 102 surrounding the base plate 101, and a cover 103. The circuit board 20 is fixed on the base plate 101, and the prism sheet 30 is arranged above the circuit board 20 and substantially parallel to the circuit board 20. The protection cover 103 is fixed on the sidewall 102 and placed above the prism sheet 30 for protecting the prism sheet 30 and the circuit board 20 from being contaminated and damaged. In the embodiment, the protection cover 103 is made of transparent glass or transparent plastic plates. The base plate 101 and the sidewall 102 are made of metal or plastic having high reflectivity.

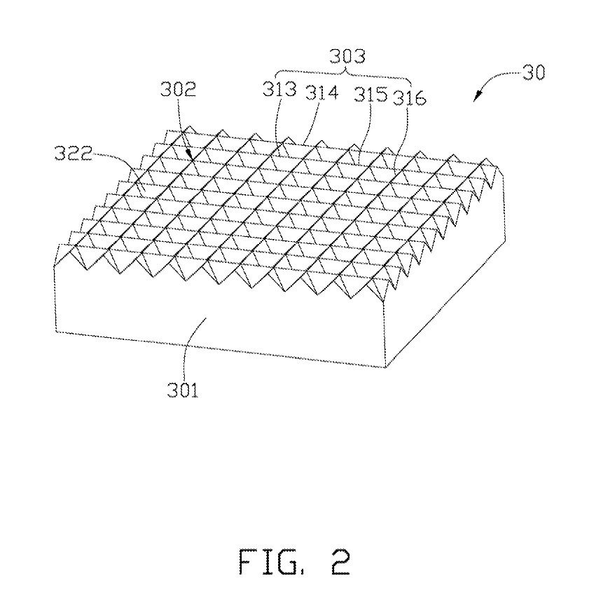

Referring to FIG. 2, the prism sheet 30 is made of transparent plastic and includes a light incident surface 301 and a light exit surface 302 opposite to the light incident surface 301. The light incident surface 301 is planar and faces the circuit board 20. A number of V-shaped micro-grooves 303 are formed on the light exit surface 302 along at least two directions. In the embodiment, an angle between two sides of each V-shaped micro-groove 303 is about 45 degrees. The V-shaped micro-grooves 303 include a number of V-shaped first micro-grooves 313 extending along a first direction X1, and a number of V-shaped second micro-grooves 314 extending along a second direction X2 substantially perpendicular to the first direction X1. The first micro-grooves 313 are arranged in parallel rows, and the second micro-grooves 314 are arranged in parallel columns. The micro-groove rows intersect with the micro-groove columns to form a number of four-pointed stars 322 at the intersections. A number of virtual light sources 203 are formed on the circuit board 20 when the light is emitted by an LED unit 201 to the prism sheet 30. In the embodiment, four virtual light sources 203 are formed on the circuit board 20 after the light emitted by the LED unit 201 passes through the prism sheet 30.

In other embodiments, the micro-grooves 303 may include a number of first micro-grooves 313 extending along a first direction X1, a number of second micro-grooves 314 extending along a second direction X2, and a number of third micro-grooves 315 extending along a third direction X3 intersecting with the first direction X1 and the second direction X2. The angle of adjacent two of the extending directions X1, X2, X3 of the micro-grooves 303 is about 60 degrees, such that six virtual light sources 203 are formed on the circuit board 20 after the light emitted by an LED unit 201 passes through the prism sheet 30. The micro-grooves 303 may also include a number of V-shaped fourth micro-grooves 316 extending along a direction that intersects with the first direction X1, the second direction X2, and the third direction X3. The angle of adjacent two of the extending directions is about 45 degrees, such that eight virtual light sources 203 are formed on the circuit board 20 after the light emitted by an LED unit 201 passes through the prism sheet 30.

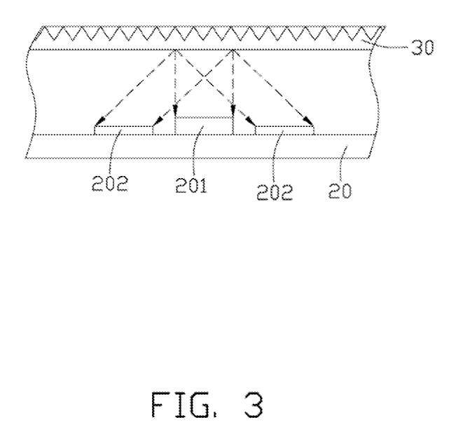

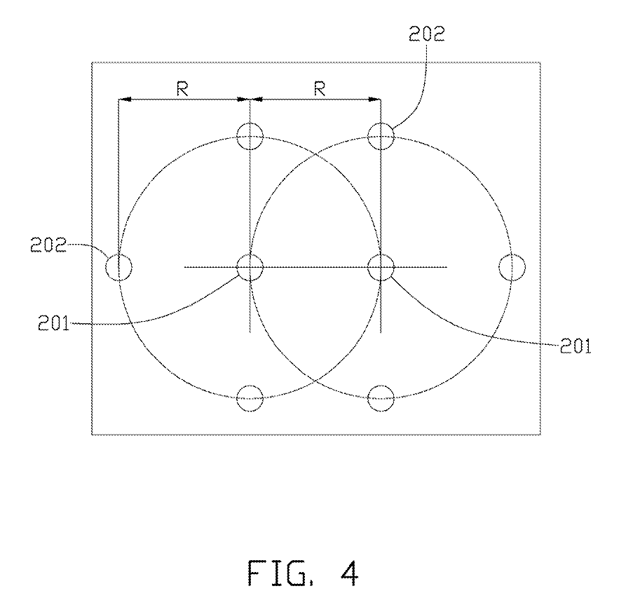

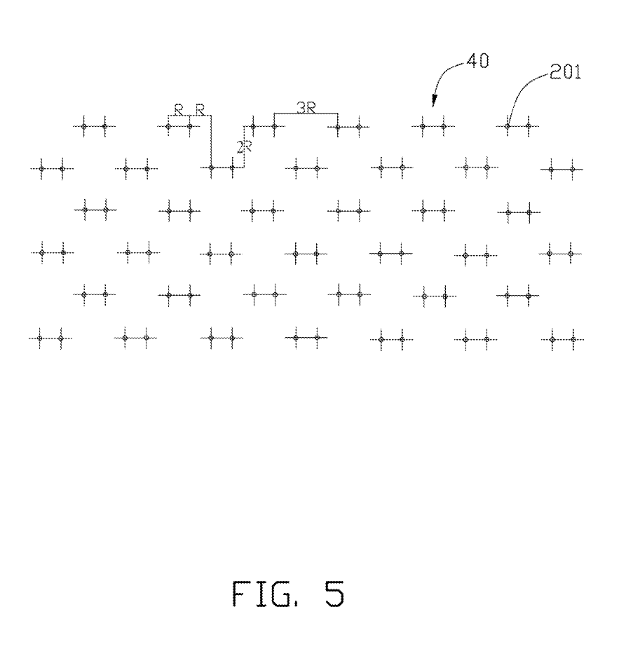

Referring to FIGS. 3-5, each two LED units 201 form an LED illuminating array 40. A number of LED illuminating arrays 40 are arranged in a matrix (see FIG. 5). The four virtual light sources 202 are reflected to the circuit board 20 by the four-pointed stars 322 of the prism sheet 30 when light is emitted by a particular LED unit 201. The four virtual light sources 202 are generally distributed on a circle whose center coincides with the particular LED unit 201. The value of the radius R of the circle is related to the distance between the prism sheet 30 and the LED units 201. The rows of the matrix formed by the LED illuminating arrays 40 are spaced apart a first preset distance, and the columns of the matrix are spaced apart a second preset distance. Each two LED units 201 in one LED illuminating array 40 are spaced apart a third preset distance. In the embodiment, the first preset distance is 2R, the second preset distance is 4R, and the third preset distance is R.

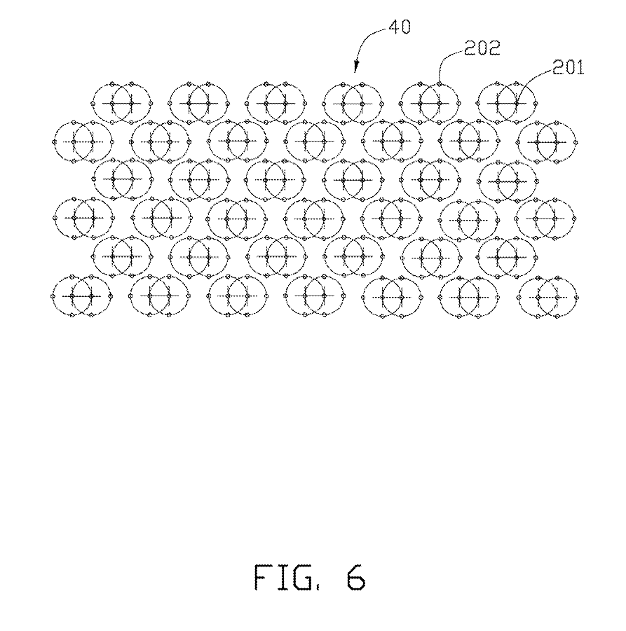

Referring to FIG. 6, a virtual light source matrix is formed to enhance the brightness of the LED illuminating device 100 and to reduce the number of LED units 201.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED illuminating device comprising:
a housing comprising a base plate;
a prism sheet mounted in the housing and comprising a plurality of V-shaped micro-grooves formed thereon along at least two directions intersecting with each other; and
a circuit board fixed on the base plate, wherein a plurality of LED illuminating arrays are arranged on the circuit board to form a matrix, each LED illuminating array comprises two LED units, at least four virtual light sources are formed by reflection of the prism sheet to the circuit board after the light is emitted by a particular LED unit on circuit board; the rows of the matrix are spaced apart a first preset distance, and the columns of the matrix are spaced apart a second preset distance, and each two LED units in one LED illuminating array are spaced apart a third preset distance.

2. The LED illuminating device of claim 1, wherein the colors of each LED units are the same as other LED units, the virtual light sources are distributed on a circle whose center coincides with a particular one of the LED units in each LED illuminating array.

3. The LED illuminating device of claim 1, wherein the prism sheet comprises a light incident surface and a light exit surface opposite to the light incident surface; the light incident surface is planar and faces the circuit board; the plurality of V-shaped micro-grooves are formed on the light exit surface.

4. The LED illuminating device of claim 1, wherein the V-shaped micro-grooves comprise a plurality of a V-shaped first micro-grooves extending along a first direction, and a plurality of a V-shaped second micro-grooves extending along a second direction perpendicular to the first direction.

5. The LED illuminating device of claim 1, wherein the prism sheet is made of transparent plastic.

6. The LED illuminating device of claim 1, wherein the housing comprises a sidewall extending around the base plate, the circuit board is fixed on the base plate, the prism sheet is arranged above the circuit board.

7. The LED illuminating device of claim 1, wherein the prism sheet is substantially parallel to the circuit board.

8. The LED illuminating device of claim 1, further comprising a protection cover, wherein the protection cover is fixed on the sidewall above the prism sheet for protecting the prism sheet and the circuit board from being contaminated and damaged.

9. The LED illuminating device of claim 5, wherein the base plate and the sidewall are made of metal or plastic having high reflectivity.

10. The LED illuminating device of claim 2, wherein the first preset distance is twice the radius of the circle, the second preset distance is quadruple radius of the circle, and the third preset distance equals the radius of the circle.
